(19) United States
(12) Patent Application Publication
(10) Pub. No.: US 2003/0010622 A1
(43) Pub. Date: Jan. 16, 2003

(54) Process for making a C6 to C12 dibasic acid or azelaic acid using ozone generated from carbon dioxide

(76) Inventor: Edward F. Moran JR., Gibbstown, NJ (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/176,928

(22) Filed: Jun. 21, 2002

Related U.S. Application Data
(63) Continuation-in-part of application No. 09/774,474, filed on Jan. 31, 2001, now abandoned.

(51) Int. Cl. H05F 3/00

(52) U.S. Cl. 204/165; 204/164

(57) ABSTRACT

Process for making C6 to C12 dibasic acids or azelaic acid using ozone generated from substantially pure carbon dioxide.

### RELATED APPLICATION

This application is a continuation-in-part of application Ser. No. 09/774,474, filed Jan. 31, 2001.

### FIELD OF THE INVENTION

The present invention is directed toward the production of a C6 to C12 dibasic acid or azelaic acid using ozone generated from carbon dioxide.

### BACKGROUND OF THE INVENTION

In the commercial production of ozone, oxygen or air of high purity is fed to an ozone generator. Ozone is produced from the dissociation of oxygen molecules under the influence of an energy source and their recombination as ozone. Ozone is produced in commercial quantities primarily by two processes: electronic (corona discharge) and photochemical (ultraviolet light). Other methods include high-density electrolysis of aqueous phosphate solution and irradiation of oxygen with β- or γ-rays from a nuclear reactor or radioactive isotopes.

Generation of ozone from air is problematic when the ozone is to be used in chemical reactions. Some of the nitrogen in the air is converted to nitrogen oxides that can react with chemical reactants to form undesirable nitrated products. When high purity oxygen is converted to ozone, the conversion does not exceed 20 percent in even the most efficient ozone generators. When the ozone-containing gas stream is used for a chemical reaction the ozone is nearly totally consumed, leaving an oxygen-containing gas mixture in contact with organic materials, which may create an explosion hazard. Methods have been employed to avoid this situation, all of which can add to the expense of conducting the reaction. One method is the addition of an inert diluent to the ozone producing gas stream. See, British Patent No. 1,536,345. Another method is conducting the reaction with a low volatility solvent. Another method involves the installation of elaborate engineering controls. See, Wasser '81 [Einundachtzig] (1981) Volume 2, 314-24 Publisher: Colloq.Verlag Otto H. Hess, Berlin, Fed. Rep. Ger.

### SUMMARY OF THE INVENTION

The present invention provides a process for making a C6 to C12 dibasic acid or azelaic acid, comprising the sequential steps of

(1) passing substantially pure carbon dioxide between at least one pair of electrodes, the at least one pair of electrodes having a voltage difference between them sufficient to cause a corona discharge across them, thereby generating a gas comprising ozone with substantially no oxygen;

(2) contacting the gas produced in step (1) with (a) a C6 to C12 cycloalkene or (b) oleic acid to produce (a) a C6 to C12 cycloalkene ozonide or (b) oleic acid ozonide, respectively; and

(3) contacting the (a) C6 to C12 cycloalkene ozonide or (b) oleic acid ozonide with an oxygen-containing gas to produce (a) the C6 to C12 dibasic acid or (b) azelaic acid, respectively.

When ozone is produced from carbon dioxide, the ozone so produced will be substantially oxygen-free. Such ozone may be used in the above-recited process without the danger of forming flammable or explosive mixtures, so the need to choose solvents for the sake of safety will be largely negated. Moreover, carbon dioxide is inexpensive and readily available.

### DETAILED DESCRIPTION OF THE INVENTION

In the present invention, carbon dioxide, C0₂, can be fed to a commercially available ozone generator to produce ozone. Currently, two methods are used to produce ozone in commercial quantities: corona discharge and ultraviolet light. The present invention involves the use of corona discharge.

Corona discharge involves passing substantially pure carbon dioxide between two electrodes having a voltage across them. Commonly, the positive electrode consists of glass [typically borosilicate glass] with a thin metal electrode [typically aluminum, Nichrome, or silver-plated] etched or otherwise placed on the glass surface. The negative ground electrode is typically a metal electrode such as stainless steel. Often an ozone generation unit will contain multiple positive electrode and ground electrode pairs. The voltage supplied to the electrode is not critical and may be from about 5 to 20 kV at 50-3000 Hz. Low voltage has an advantage of simplicity and reliability. Higher voltage often provides greater power efficiency. Commercial ozone generators may be single- or double-fluid-cooled generators. See, Ozone News 26(5), 33 (1998), and Kirk-Othmer, Encyclopedia of Chemical Technology, vol. 17, 970 (1996).

The term “substantially pure carbon dioxide,” as used herein, is meant to denote carbon dioxide having less than about 5% oxygen by weight. Other gases, such as argon and helium, may be present. In general, the amount of oxygen in the carbon dioxide feed stock should be kept below the explosive limit for any system (reactor in which the ozone/oxygen mixture is reacted with chosen reactants, vapor space of the gas exiting the reactor, etc.).

Once the ozone is produced, it is important to react it quickly. The ozone may be contacted with a C6 to C12 cycloalkene to produce the corresponding C6 to C12 ozonide (e.g. cyclohexene ozonide to cyclododecene ozonide) and then contacting the ozonide with an oxygen-containing gas (e.g. air) to produce the corresponding C6 to C12 dibasic acid (e.g. adipic to dodecanedioic acid). Preferred C6 to C12 cycloalkenes are cyclohexene, cycloheptene, cyclooctene and cyclododecene. Most preferred are cyclohexene and cyclododecene, because they can be converted into important nylon intermediates—adipic acid and dodecanedioic acid, respectively.

The ozone may also be contacted with oleic acid to produce oleic acid ozonide and then contacting the ozonide with an oxygen-containing gas to produce azelaic acid.

Typical reaction conditions for the reaction of ozone with C6 to C12 cycloalkenes or oleic acid are low temperature (e.g. −30 to 30° C.), short contact times (e.g. in the order of 1-3 minutes) and at sufficient pressure to retain the reactants. Typical conditions for the reaction of the ozonide with an oxygen containing gas are higher temperature (e.g. 60 to 180° C.), longer contact times (e.g. in the order of 1-8 hours) and at sufficient pressure to retain the reactants.

The process of the present invention is illustrated by the following nonlimiting examples.

### EXAMPLES

### Example 1

### Ozonolysis of Cyclododecene with Ozone Produced from Carbon Dioxide in an Ozone Generator

This example illustrates the ozonolysis of cyclododecene with ozone produced from carbon dioxide in an ozone generator to an ozonide intermediate and its subsequent rearrangement to 12-oxo-dodecanoic acid and further oxidation to dodecanedioic acid, a valuable nylon intermediate.

Ozone was generated with a ClearWater Tech, Inc. corona discharge ozone generator Model M-1500 (240 V, 50/60 Hz, and 1.0 amps). Carbon dioxide gas from a cylinder was fed to the ozone generator at 100 cubic centimeters per minute. The carbon dioxide was obtained from MG Industries, Malvern, PA. It was analyzed to be 99.99% minimum carbon dioxide. After exiting the ozone generator the gas stream was analyzed for ozone level with an ozone monitor, model HC-NEMA 12, manufactured by PCI Ozone & Control Systems, Inc., West Caldwell, N.J. After the ozone concentration reached a steady state, the stream was redirected to a reaction vessel. The reactor was a cylindrical vessel with a tube that reached nearly to the bottom of the vessel, through which the ozone-containing gas stream was introduced into the vessel. On the end of the tube was a cylindrical fritted glass gas dispersion tube. The gas exiting the reactor was directed to a gas-washing bottle with a cylindrical fritted glass gas dispersion tube. The gas-washing bottle contained a 2% solution of potassium iodide. When the material being ozonized in the reaction vessel was consumed, ozone passed through to the washing bottle and oxidized iodide to iodine, imparting a yellow color to the solution. The gas stream was then redirected to the ozone monitor to re-check its concentration in the gas stream.

The reaction vessel was charged with 35 grams of acetic acid and 6.0 grams of cyclododecene which analyzed 96.8% cyclododecene and 2.5% cyclododecane. Gas from the ozone generator as described above was passed through the reactor. The temperature of the reactor was kept between 20 and 24° C. during the run. After 1020 minutes the solution of potassium iodide turned yellow indicating that the ozone was no longer being consumed. The average ozone concentration, calculated as the average of the readings on the ozone monitor at the start and at the conclusion of the experiment, was 0.905%. The vessel containing the ozonolysis product (the ozonide) was then heated at 80° C. while oxygen gas was passed through the cylindrical fritted glass gas dispersion tube for a period of 3 hours. This procedure was necessary to completely oxidize the ozonide and aldehyde intermediate products to acidic products. On cooling a solid precipitated out. The solid was separated by filtration and dried in a vacuum oven at 80° C. for 18 hours. The dried solid product contained 3.00 grams of dodecanedioic acid as determined by calibrated liquid chromatography. The liquid filtrate resulting from the separation of the solid product weighed 16.72 grams and contained 0.67 grams dodecanedioic acid by calibrated Gas Chromatographic analysis. The yield of dodecanedioic acid from cyclododecene was 45.6%.

### Example 2

### Ozonolysis of Oleic Acid with Ozone Produced from Carbon Dioxide in an Ozone Generator

This example illustrates the ozonolysis of oleic acid with ozone produced in accordance with the present invention to an ozonide intermediate and its subsequent rearrangement and further oxidation to nonanoic acid and azelaic acid, a valuable nylon intermediate that is produced commercially.

The reaction setup and experimental procedure described in Example 1 were followed. The reactor was charged with 10.89 grams of oleic acid, which analyzed 89.99% oleic acid and 35 grams of acetic acid. Gas from the ozone generator was passed through the reactor for 1262 minutes. The average ozone concentration was calculated to be 0.89%. After the 3 hour oxygen oxidation at 80° C. a clear solution was obtained which contained 0.15 grams of oleic acid, 3.85 grams nonanoic acid and 4.74 grams of azelaic acid by calibrated Gas Chromatographic analysis. The yield of azelaic acid from oleic acid was 73.18%.

What is claimed is:

1. A process for making a C6 to C12 dibasic acid or azelaic acid, comprising the sequential steps of
(1) passing substantially pure C02 between at least one pair of electrodes, the at least one pair of electrodes having a voltage difference between them sufficient to cause a corona discharge across them, thereby generating a gas comprising ozone with substantially no oxygen;
(2) contacting the gas produced in step (1) with (a) a C6 to C12 cycloalkene or (b) oleic acid to produce (a) a C6 to C12 cycloalkene ozonide or (b) oleic acid ozonide, respectively; and
(3) contacting the (a) C6 to C12 cycloalkene ozonide or (b) oleic acid ozonide with an oxygen-containing gas to produce (a) the C6 to C12 dibasic acid or (b) azelaic acid, respectively.

2. The process of claim 1 wherein the C6 to C12 cycloalkene is cyclohexene and the C6 to C12 dibasic acid is adipic acid.

3. The process of claim 1 wherein the C6 to C12 dibasic acid is cyclododecene and the C6 to C12 dibasic acid is dodecanedioic acid.
